(19) United States
(12) Patent Application Publication
(10) Pub. No.: US 2024/0369713 A1
(43) Pub. Date: Nov. 7, 2024

(54) DEVICE AND METHOD FOR POSITIONING AN AIRCRAFT

(71) Applicant: SICK AG, Waldkirch (DE)

(72) Inventors: Dominic RUH, Waldkirch (DE); Steffen WITTMEIER, Waldkirch (DE)

(21) Appl. No.: 18/484,703

(22) Filed: Oct. 11, 2023

(30) Foreign Application Priority Data
Oct. 11, 2022 (EP) 22200957.3

(51) Int. Cl. G01S 17/933; G01S 17/06; G08G 5/06

(52) U.S. Cl. CPC G01S 17/933; G01S 17/06; G08G 5/06

(57) ABSTRACT

A device for the positioning of an aircraft in a monitored zone of an apron of an airport has at least one optoelectronic sensor for transmitting transmitted light beams into the monitored zone, for scanning a plurality of measurement points, and for generation measurement data from transmitted light remitted or reflected by the measurement points. A control and evaluation unit is configured to segment the measurement points, to at least partially combine them into segments of the aircraft, to extract features of the segments, to associate the segments with an aircraft from a plurality of aircraft types with reference to the extracted features, and to output positioning information for the aircraft based on the associated aircraft type. The at least one optoelectronic sensor is designed as an FMCW LIDAR sensor and the measurement data comprise radial speeds of the measurement points.

The invention relates to a device and to a method for positioning an aircraft in a monitored zone of an apron of an airport respectively.

The most varied systems are known from the prior art for the positioning of aircraft on an apron of an airport, in particular for docking an aircraft at a jet bridge. As a rule, an aircraft is detected with the aid of optoelectronic sensors here and the aircraft type is determined with reference to specific segments of the aircraft and their shapes, for example the shape of the aircraft nose (radome), its distance from the ground, or the position and/or shape of the engines. With knowledge of the dimensions of the aircraft type and of the position of the aircraft detected by the optoelectronic sensors, the aircraft can then be led to a predetermined parking position or the docking of the aircraft at the jet bridge can be controlled or assisted. The pilot of the aircraft can be assisted for this purpose, for example, by an airport docking guidance system. The airport docking guidance system comprises a display that is attached in the field of vision of the pilot to display information to the pilot in the cockpit and a LIDAR sensor that measures the position of the aircraft relative to the parking position. In addition to the measurement of the position of the aircraft with respect to the parking position, the LiDAR sensor also has to deliver information that makes the classification of the aircraft type with reference to the detected segments of the aircraft possible since the parking position depends on the aircraft type.

DE 4301637C3 describes methods of docking an aircraft at a jet bridge of an airport building by locating and guiding the aircraft from a starting position to a jet bridge using a laser transmitter and laser reception device.

EP 2 109 065 B1 relates to a method of localizing and identifying objects, in particular aircraft on an airfield, and of a safe and efficient docking of aircraft at such an airport, with the identification taking place in a two-step method. A contour of an aircraft is first detected here and is compared with known contours and, in a second step, components of the aircraft, for example an engine, are detected and are selected as a basis for distinguishing between aircraft. The detection of the contours and the aircraft components takes place by means of a laser range finder.

A method is known from U.S. Pat. No. 7,702,453 B2 of guiding an aircraft to a stop position within an aircraft stand of an airport using a radio frequency (RF) signal from an RFID tag. A laser range finder can support the method.

EP 1 015 313 B1 shows a docking system for airport terminals having a positioning device as part of a gate operating system of an airport terminal by means of which an aircraft can be guided to a parking position specified for its type. A video device detects the aircraft on its approach to the airport terminal and the detected data are compared with a database in which respective template datasets are stored for different types of aircraft.

The image capturing system typically used in the prior art for detecting the aircraft, in particular laser scanners and camera systems, however, have disadvantages that will be looked at in more detail in the following.

Laser scanners or LiDAR (light detection and ranging) sensors are typically based on a direct time of flight measurement of light. In this respect, a light pulse is emitted by the sensor, is reflected at an object, and is detected by the sensor again. The time of flight of the light pulse is determined by the sensor and the distance between the sensor and the object is estimated via the speed of light in the propagation medium (air as a rule). Since the phase of the electromagnetic wave is not taken into account here, an incoherent measurement principle is spoken of. There is the necessity in an incoherent measurement to build up pulses from a plurality of photons to receive the reflected pulse with a sufficient signal-to-noise ratio. The number of photons within a pulse is upwardly limited as a rule by eye protection in an industrial environment. As a consequence, trade-offs result between maximum range, minimal remission of the object, integration time, and the demands on the signal-to-noise ratio of the sensor system. Incoherent radiation at the same wavelength (ambient light) additionally has a direct effect on the dynamic range of the light receiver. Examples for incoherent radiation at the same wavelength are the sun, similar sensor systems, or the identical sensor system via a multipath propagation, that is unwanted reflections.

Camera systems known from the prior art are based on measurement principles such as stereoscopy or indirect time of flight measurement. In indirect time of flight measurement, the phase difference of an AMCW (amplitude modulated continuous wave) transmission signal and its time delayed copy after reflection by an object is determined. The phase difference corresponds to the time of flight and can be converted into a distance value via the speed of light in the propagation medium. Both stereoscopy and indirect time of flight measurement are, however, not especially robust with respect to solar radiation and do not achieve the required range for the airport docking application, in particular when using so-called flash illumination in which the whole scene is illuminated at once. The accuracy of the detection of the aircraft or of the relevant features such as the engine position or the shape of the aircraft nose may therefore be unsatisfactory overall and the processing effort for the image processing is high as a rule.

It is therefore the object of the invention to improve a device and a method for positioning an aircraft in a monitored zone of an apron of an airport.

This object is satisfied by a device and a method for positioning an aircraft in a monitored zone in an apron of an airport in accordance with the respective independent claim.

A device for positioning an aircraft first has at least one optoelectronic sensor that transmits transmitted light beams into a monitored zone of an apron of an airport for the detection of the aircraft. The transmitted light beams scan a plurality of measurement points in the monitored zone and the sensor generates measurement data from transmitted light remitted or reflected by the measurement points. The scanner can have beam deflection means typical in the art for the scanning of the monitored zone and can be designed, for example, as a scanner having at least one movable deflection mirror.

A control and evaluation device is configured to evaluate the generated measurement data, with first a segmentation of the measurement points taking place and the measurement points being at least partially combined into segments of the aircraft. “At least partially” in this context means that some of the measurement points scanned in the monitored zone can relate to objects that are not part of the aircraft, for example persons or vehicles located on the apron or also the apron itself. The segmentation can take place in accordance with known processes of digital image processing or of machine vision such as
pixel oriented processes in a gray scale image by means of threshold processes;
edge oriented processes such as the Sobel or Laplace operator and a gradient search;
region oriented processes such as “region growing”, “region splitting”, “pyramid linking”, or “split and merge”;
model based processes such as the Hough transformation; or
texture oriented processes.

Special processes for segmenting three-dimensional datasets are furthermore known under the term “range segmentation”. The “range segmentation” is, for example, described in the following scientific publications:
“Fast Range Image-Based Segmentation of Sparse 3D Laser Scans for Online Operation” (Bogoslavskyi et al., 2016 IEEE/RSJ International Conference on Intelligent Robots and Systems, DOI: 10.1109/IROS.2016.7759050)
“Laser-based segment classification using a mixture of bag-of-words”. (Behley et al., 2013 IEEE/RSJ International Conference on Intelligent Robots and Systems, DOI: 10.1109/IROS.2013.6696957)
“On the segmentation of 3d lidar point clouds” (Douillard et al., 2011 IEEE International Conference on Robotics and Automation, DOI: 10.1109/ICRA.2011.5979818)

Algorithms of machine learning can furthermore be used to detect segments of the aircraft or the complete aircraft. So-called deep neural networks are used for this purpose in accordance with the current state of the art. Examples for such processes are, for example, described in the following scientific publications:
Guo, Yulan, et al. “Deep learning for 3d point clouds: A survey.” IEEE transactions on pattern analysis and machine intelligence 43.12 (2020): 4338-4364.
Lang, Alex H., et al. “Pointpillars: Fast encoders for object detection from point clouds.” Proceedings of the IEEE/CVF conference on computer vision and pattern recognition. 2019.
Yan, Yan, Yuxing Mao, and Bo Li. “Second: Sparsely embedded convolutional detection.” Sensors 18.10 (2018): 3337.

In particular those parts of the aircraft are to be understood as segments of the aircraft that are characteristic for a specific aircraft type due to features such as shape and/or position, for example engines, landing gear, cockpit windows, or tailplane rudders. The term “segment of the aircraft” can also comprise an outline of the aircraft provided that the aircraft is detected in its totality by the sensor.

The control and evaluation unit is therefore furthermore configured to extract features of the segments, to associate the segment to an aircraft type with reference to the extracted features, and to output positioning information for the aircraft based on the associated aircraft type, for example a distance and/or a direction to a predetermined parking position specific to the aircraft type. To associate the segments with an aircraft type, the control and evaluation unit can be configured to receive information on segments specific to an aircraft type, from a database, for example. The database can be part of the device or of the control and evaluation unit itself, part of an IT infrastructure of the airport, or can also be present in a cloud.

In accordance with the invention, the optoelectronic sensor is formed as a frequency modulated continuous wave (FMCW) LIDAR sensor. The principles of FMCW LiDAR technology are, described, for example, in the scientific publication “Linear FMCW Laser Radar for Precision Range and Vector Velocity Measurements” (Pierrottet, D., Amzajerdian, F., Petway, L., Barnes, B., Lockard, G., & Rubio, M. (2008). Linear FMCW Laser Radar for Precision Range and Vector Velocity Measurements. MRS Proceedings, 1076, 1076-K04-06. doi: 10.1557/PROC-1076-K04-06) or the doctoral thesis “Realization of Integrated Coherent LIDAR” (T. Kim, University of California, Berkeley, 2019. https://escholarship.org/uc/item/1d67v62p).

Unlike LiDAR sensors based on time of flight measurement of laser pulses or laser range finders, an FMCW LiDAR sensor does not transmit pulsed transmitted light beams into a monitored zone, but rather continuous transmitted light beams that have a predetermined frequency modulation, that is a time variation of the wavelength of the transmitted light during a measurement, that is a time-discrete scanning of a measurement point in the monitored zone. The measurement frequency of a total frame that can comprise 100,000 measurement points or more is here typically in the range from 10 to 30 Hz. The frequency modulation can be formed, for example, as a periodic up and down modulation. Transmitted light reflected by measurement points in the monitored zone has, in comparison with irradiated transmitted light, a time delay corresponding to the time of light that depends on the distance of the measurement point from the sensor and is accompanied by a frequency shift due to the frequency modulation. Irradiated and reflected transmitted light are coherently superposed in the FMCW LiDAR sensor, with the distance of the measurement point from the sensor being able to be determined from the superposition signal. The measurement principle of coherent superposition inter alia has the advantage in comparison with pulsed or amplitude modulated incoherent LiDAR measurement principles of increased immunity with respect to extraneous light from, for example, other optical sensors/sensor systems or the sun.

If a measurement point moves toward the sensor or away from the sensor at a radial speed, the reflected transmitted light additionally has a doppler shift. An FMCW LIDAR sensor can determine this change of the transmitted light frequency and can determine the distance and the radial speed of a measurement point from it in a single measurement, that is in a single scan of a measurement point, while at least two measurements, that is two scans spaced apart in time of the same measurement point are required in a determination of the radial speed with a LIDAR sensor based on a time of flight measurement of laser pulses.

On a time-discrete and spatially discrete scan of a three-dimensional monitored zone, an FMCW LiDAR sensor can detect or generate the following measurement data:

$${M}_{j , k , l} = ( \begin{matrix}{r}_{j , k , l} \\ {v}_{j , k , l}^{r} \\ {I}_{j , k , l}\end{matrix} ) .$$

Where r_{j,k,l} is the radial distance, v^{r}_{j,k,l} the radial speed, and I_{j,k,l} the intensity of each spatially discrete measurement point j,k with a two-dimensional position (φⱼ, θₖ) specified by an azimuth angle φ and a polar angle θ for every time-discrete scan I. For better legibility, the index n is used in the following for a single, time-discrete, scanning of a spatially discrete, two dimensional measurement point (φⱼ, θₖ) in the three-dimensional monitored zone. The measurement data generate by the FMCW LiDAR sensor thus comprise the radial speeds of the measurement points in addition to their location and intensity information.

In the case of single mode emitting FMCW LiDAR sensors, very small laser beams can be generated having diameters in the range of millimeters for scanning the measurement zone. Due to the high measurement information density of the FMCW LiDAR sensor, less complex and more robust algorithms can be used to determine positioning information of an aircraft relative to the parking position.

The control and evaluation unit can be configured to segment the measurement points using the radial speeds of the measurement points. An improved segmentation of the measurement data is possible by the use of the spatially resolved radial speed as an additional parameter to the customary location and intensity information.

The control and evaluation unit can be configured to determine a movement pattern of the first segment using spatially resolved radial speeds of measurement points associated with at least one first segment. A movement pattern is to be understood as a characteristic own movement of the segment, for example a rotation or a relative movement of the segment with respect to the aircraft itself or with respect to a further object segment that results from a radial speed profile of the measurement points associated with the segment. A corresponding characteristic own movement or characteristic radial speed can, for example, be stored in the control and evaluation unit as a predetermined movement pattern, can be detected in a teaching process, or can be determined during the operation of the device by means of methods of machine learning or artificial intelligence.

The use of the spatially resolved radial speeds to determine a movement pattern of the measurement points associated with a first segment has the advantage that the movement pattern of the segment can be determined quickly and reliably.

The determination of a movement pattern of a segment, in particular the determination of a relative movement between different segments or of segments with respect to the aircraft itself, can be used, for example, to identify the rotating engine blades and thus the engine of the aircraft.

The recognition of the landing gear of the aircraft can, for example, be improved using the movement pattern of wheels of the aircraft since the movement patterns of the wheels differ from the movement pattern of the fuselage. Since the nose landing gear has different tire sizes than the main landing gear as a rule, the movement patterns of the corresponding wheels also differ so that an improved distinguishing and localizing of the main and nose landing gear is possible.

In an embodiment, the control and evaluation unit can be configured to filter the measurement data using the radial speeds of the measurement points. The processing effort can thus already be reduced by data reduction before a segmentation of the measurement points. A filtering can take place, for example, in that measurement points having a radial speed that is smaller than, greater than, or equal to a predefined threshold value are discarded and are not supplied to any further evaluation. Measurement points belonging to an aircraft in motion can thereby, for example, be separated from those that belong to a static background and the data quantity for following processing steps can thus be reduced.

In an embodiment, the control and evaluation unit can be configured to determine a speed of the aircraft using the radial speed of the measurement points and to compare the determined speed with a specified speed limit, with the positioning information for the aircraft then being able to include the speed of the aircraft and/or information on exceeding of the specified speed limit. The speed or a 3D speed vector of the aircraft can, for example, be calculated by the method of estimating the speed described in “Doppler velocity-based algorithm for Clustering and Velocity Estimation of moving objects (Guo et al., 2022)”.

The FMCW LiDAR sensor can be additionally configured to detect position dependent intensities of the transmitted light reflected or remitted by the measurement points. For this purpose, the FMCW LiDAR sensor has a decoupling unit that is configured to decouple at least some of the transmitted light reflected or remitted by the measurement points in the monitored zone, also called received light in the following, and to guide it to a polarization analyzer. The polarization analyzer is configured to measure the polarization dependent intensities of the received light, for example by polarization dependent splitting of the received light by a polarizing beam splitter cube or a metasurface, and measuring the intensities of the split received light by suitable detectors.

On a time-discrete and spatially discrete scan of a three-dimensional monitored zone, an FMCW LIDAR sensor configured in this manner can thus detect the following measurement data:

$${M}_{j , k , l} = ( \begin{matrix}{r}_{j , k , l} \\ {v}_{j , k , l}^{r} \\ {I}_{⊥ j , k , l} \\ {I}_{‖ j , k , l}\end{matrix} ) .$$

where r_{j,k,l} is the radial distance, v^{r}_{j,k,l} the radial speed, and I_{⊥,j,k,l} and I_{∥j,k,l} the polarization dependent intensities of each spatially discrete measurement point j, k with a two-dimensional position (φⱼ, θₖ) specified by an azimuth angle φ and a polar angle θ for every time-discrete scan I. For better legibility, the index n is used in the following for a single, time-discrete, scanning of a spatially discrete, two dimensional measurement point (φⱼ, θₖ) in the three-dimensional monitored zone.

To evaluate the polarization dependent intensities additionally detected by the FMCW LIDAR sensor, the control and evaluation unit can be configured to segment the measurement points using the spatially resolved radial speed of the measurement points and the polarization dependent intensities of the transmitted light reflected or remitted by the measurement points and to associated them with segments of the aircraft.

A further improved segmentation of the measurement data is possible by the use of the spatially resolved radial speed and the polarization dependent intensities of the transmitted light reflected or remitted by the measurement points as additional parameters. An improved recognition of cockpit windows of an aircraft can take place, for example, by evaluating the polarization dependent intensities since transmitted light beams reflected by the window panes of the cockpit windows differ with respect to the polarization dependent intensities of transmitted light beams that were reflected by the fuselage of the aircraft.

The FMCW LiDAR sensor can be arranged at a jet bridge and can scan a predetermined monitored zone, for example the apron disposed in front of the jet bridge. At least one further FMCW LiDAR sensor can preferably be provided that scans a further monitored zone, with the monitored zones being able to overlap. Shading or blind angles in which no object detection is possible can thereby be avoided. If two or more FMCW LiDAR sensors are arranged with respect to one another such that measurement beams can be generated that are orthogonal to one another, a speed vector of an object scanned by these measurement beams in the plane spanned by the mutually orthogonal measurement beams can be determined by offsetting these measurement beam pairs.

The sensor can be designed as a safety sensor, for example in the sense of the standards EN13849 for machine safety and the machine standard IEC61496 or EN61496 for electrosensitive protective equipment (ESPE). The sensor then works particularly reliably and satisfy high safety demands and can have redundant diverse electronics, a redundant function monitoring, or a special monitoring of contamination of optical components. The control and evaluation unit can then in particular be configured to combine measurement points into objects that are not part of the aircraft, for example persons or vehicles on the apron, to extract features of these objects, and, for example on determination of an unauthorized object on the apron, to trigger a safety related action, for example the output of an optical and/or acoustic warning signal. The device can thus additionally be used to position the aircraft for apron monitoring.

The control and evaluation unit can have at least one digital processing module and can be integrated in or connected to the sensor, for instance in the form of a superior control that transfers the positioning information of the aircraft to the aircraft itself. At least some of the functionality can also be implemented in a remote system or in a cloud.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

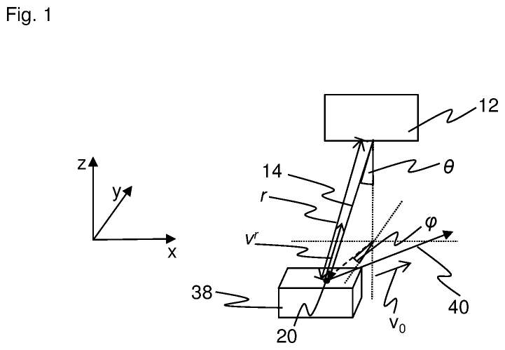

FIG. 1 an example for a radial speed measurement using an FMCW LiDAR sensor;

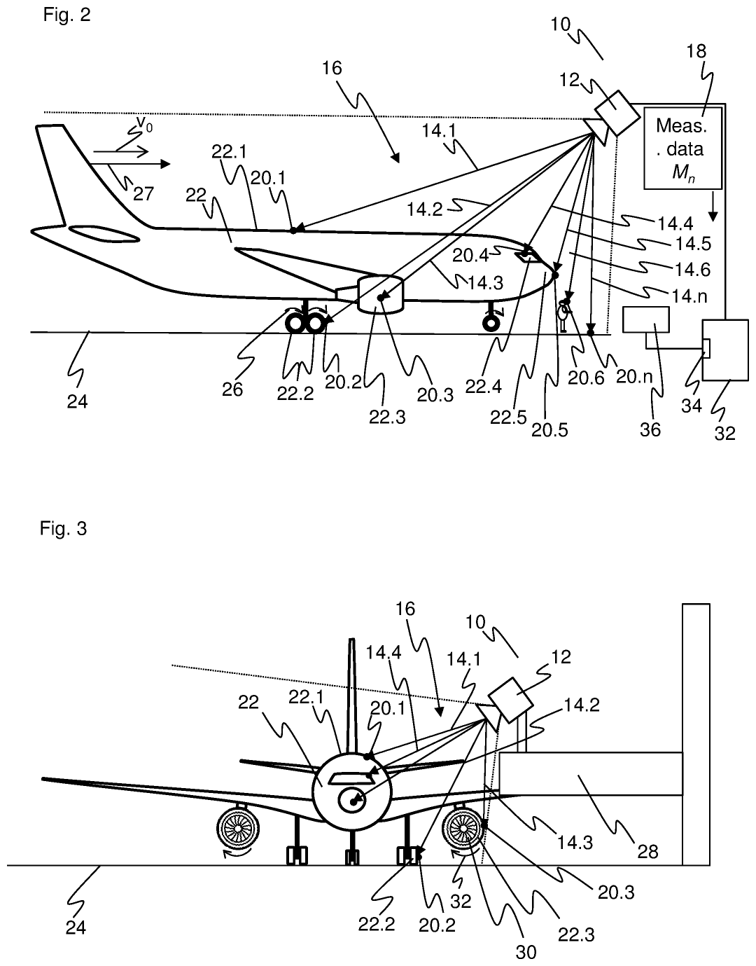

FIG. 2 a schematic representation of a device in accordance with the invention for detecting an aircraft in a side view;

FIG. 3 a schematic representation of a device in accordance with the invention for detecting an aircraft in a frontal view;

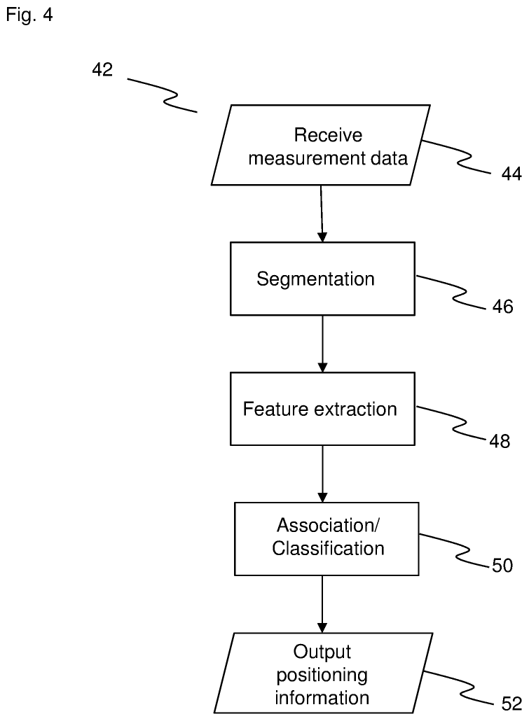

FIG. 4 a flowchart for an exemplary processing in accordance with the invention of measurement data of an FMCW LIDAR sensor.

The concept of the radial speed measurement using an FMCW LiDAR sensor 12 is shown for a three-dimensional example in FIG. 1. If an object 38 moves at a speed v₀ along a direction of movement 40 relative to the FMCW LiDAR sensor 12, the FMCW LiDAR sensor 12 can determine the radial speed v^{r} of the measurement point 20 of the object 38 in the direction of the FMCW LIDAR sensor 12 in addition to the radial distance rand the intensity I of a measurement point 20 scanned once by a transmitted light beam 14 in a time-discrete manner at an azimuth angle φ and a polar angle θ. This information is available directly with a measurement, that is a time-discrete scanning of the measurement point 20. Unlike measurement processes that only deliver spatially resolved radial distances, that is three-dimensional positions, the necessity of a second measurement and in particular the necessity of first determining the measurement points that correspond to the measurement points of the first measured in the measurement data of the second measurement is thus dispensed with for the identification of moving objects.

In the case of a static FMCW LiDAR sensor, every measurement point having a radial speed of zero is as a rule associated with a static object provided that the latter is not moved tangentially to the measurement beam of the sensor. Due to the finite object extent and to the high spatial resolution of the FMCW LiDAR sensor, practically every moving object will have at least one measurement point 20 having a radial speed v^{r}ₙ with respect to the FMCW LiDAR sensor 12 different from zero. Static and moving objects can therefore already be distinguished by a measurement of the FMCW LIDAR sensor 12. Static objects can thus be discarded, for example, on a detection of a moving aircraft. Processing efforts in the further evaluation of the measurement data are reduced by a corresponding data reduction.

FIG. 2 shows a schematic representation of a device 10 in accordance with the invention for positioning an aircraft 22 shown in a side view on an apron 24 of an airport. An FMCW LIDAR sensor 12 transmits transmitted light beams 14.1, . . . , 14.n into a three-dimensional monitored zone 16 in the apron 24 and generates measurement data Mn 18 from transmitted light reflected or remitted back to the FMCW LiDAR sensor 12 by measurement points 20.1, . . . , 20.n in the monitored zone 16. A limited number of exemplary transmitted light beams 14.1, . . . , 14.n and measurement points 20.1, . . . , 20.n is shown for the illumination; the actual number results from the size of the monitored zone 16 and the spatial resolution of the scan. The measurement points 20.1, . . . , 20.n can represent the aircraft 22 in the monitored zone 16, but also persons 26, vehicles (not shown), or the apron 24 itself.

The measurement data Mn 18 of the FMCW LiDAR sensor 12 received by the control and evaluation unit 32 in particular comprise the radial speeds v^{r}ₙ of the measurement points 20.1, . . . , 20.n for every time-discrete scan in addition to the radial distances rₙ and the intensities Iₙ, that is the remitted or reflected amount of transmitted light, where the speed component of a measurement point 20.1, . . . 20.n is designated by the radial speed v^{r}ₙ at which the measurement point 20.1, . . . , 20.n moves toward the FMCW LiDAR sensor 12 or away from the FMCW LIDAR sensor 12.

The control and evaluation unit 32 has at least one digital processing module, for example at least one microprocessor, at least one FPGA (field programmable gate array), at least one DSP (digital signal processor), at least one ASIC (application specific integrated circuit), at least one VPU (video processing unit), or at least one neural processor. The control and evaluation unit 32 can moreover be provided at least partly externally to the FMCW LiDAR sensor 12, for instance in a superior control, a connected network, an edge device, or a cloud.

The measurement data M₀ 18 are evaluated by the control and evaluation unit 32, with the control and evaluation unit 32 being configured to segment the measurement points 20.1, . . . , 20.n, to at least partly combine them into segments of the aircraft 22 such as the fuselage 22.2, the wheels 22.2 of the main landing gear, the engines 22.3, the cockpit windows 22.4, or the aircraft nose 22.5, to extract features of the segments 22.1, . . . , 22.n, to associate the segments 22.1, . . . , 22.n to an aircraft type from a plurality of aircraft types using the extracted features, and to output positioning information for the aircraft 22 via an interface 34 of the control and evaluation unit 32 on the basis of the associated aircraft type. An output unit 36 that displays the positioning information, for example in the form of a distance from a parking position of the aircraft 22 specific to the type, can be connected to the interface 34, for example.

The control and evaluation unit 32 can, for example, determine movement patterns of the object segments 22.1, . . . , 22.5, for example a rotation 26 of the wheels 22.2 of the main landing gear, using the radial speeds vin of the measurement points 20.1, . . . , 20.n and can use the detected movement patterns for the extraction of features of the segments 22.1, . . . , 22.n.

The control and evaluation unit 32 can furthermore determine a speed v₀ along a direction of movement 27 of the aircraft 22 using the radial speeds v^{r}ₙ of the measurement points 20.1, . . . , 20.n, for example using a method such as is described in the scientific paper “Doppler velocity-based algorithm for Clustering and Velocity Estimation of moving objects (Guo et al., 2022)”.

FIG. 3 shows a schematic representation of the device 10 in accordance with the invention from FIG. 2, with the aircraft being shown in a frontal view. Identical parts are provided with identical reference numerals. The FMCW LiDAR sensor 12 is arranged at a jet bridge 28.

The control and evaluation unit (not shown here) can determine a movement pattern of the engine blades 20, for example a rotation of the engine blades 30, using the radial speeds v^{r}ₙ of measurement points that detect the engine blades 30 of the engine 22.3. Since the engine blades have a very specific movement pattern due to their rotation that differs significantly from movement patterns of other segments of the aircraft 22, the position of the engine blades 30 or of the engine 22.3 can be recognized particularly reliably.

FIG. 4 shows an exemplary processing in accordance with the invention of the measurement data 12 detected by the FMCW LiDAR sensor 12 by the control and evaluation unit 32 in a flowchart 42. After the reception 44 of the measurement data, the measurement points 20.1, . . . 20.n, are segmented in a segmentation step 46 and are combined to segments 22.1, 2, . . . , 22,5, with i the spatially resolved radial speeds v^{r}ₙ of the measurement points 20.1, . . . , 20.n being able to be taken into account in addition to the spatial coordinates typically used for the segmentation 46 and the intensities of the measurement points. Segments of the aircraft can, for example, be the fuselage 22.2, the wheels 22.2, of the main landing gear, the engines 22.3, the cockpit window 22.4, or the aircraft nose 22.5.

The segmentation 46 can take place, for example, in accordance with the above-named processes of digital image processing or of machine vision or of range segmentation.

The segmentation 46 of the measurement points 20.1, . . . , 20.n can take place more efficiently and accurately using the above-named processes by the use of the radial speed vin in addition to the radial distance rₙ and the intensity Iₙ of the measurement points 20.1, . . . , 20.n. Measurement points 20.1, . . . 20.n, having radial speeds v^{r}ₙ smaller than, greater than, or equal to a predefined threshold value can be discarded and not supplied to any further evaluation. If an object such as the aircraft 22 and/or object segment such as the aircraft nose 22.5 is/are scanned by a plurality of spatially discrete measurement points and if the associated radial speeds are distinguishable, static and dynamic objects and/or object segments can be distinguished and thus stationary such as the apron 24 can already be discarded before or during the segmentation 46 of the measurement points 20.1, . . . , 20.n, and the processing effort can be reduced by data reduction.

A feature extraction 48 of the segments 22.1, . . . , 22.5 defined during the segmentation 46 takes place in the next step. Typical features that can be extracted in the processing of the measurement data from the segments 22.1, . . . , 22.5 are, for example, the width, number of measurement points, or the length of the periphery of the segments or further features such as are described, for example, in the scientific publication “A Layered Approach to People Detection in 3D Range Data” (Spinello et al., Proceedings of the Twenty-Fourth AAAI Conference on Artificial Intelligence, AAAI 2010).

After the feature extraction 48, an association or classification 50 of the segments 22.1, . . . , 22.5 with an aircraft type from a plurality of association types takes place using known classification processes such as Bayes classifiers, support vector machines, or artificial neural networks. The feature space is searched for groups of features that define a segment 22.1, . . . , 22.5 as part of the association.

An output 52 of positioning information for the aircraft 22 can take place on the basis of the result of the classification 50 based on the identified aircraft type. The positioning information here can comprise information on the distance and/or directional data on a parking position specific to an aircraft for the aircraft 22 and can be shown on a display unit for a crew of the aircraft.

1. A device for positioning an aircraft in a monitored zone of an apron of an airport having at least one optoelectronic sensor for transmitting transmitted light beams into the monitored zone, for scanning a plurality of measurement points, and for generating measurement data from transmitted light remitted or reflected by the measurement points,
a control and evaluation unit for evaluating the measurement data, with the control and evaluation unit being configured to segment the measurement points, to combine them at least partially into segments of the aircraft, to extract features of the segments, to associate the segments with an aircraft type of a plurality of aircraft types with reference to the extracted features, and to output positioning information for the aircraft on the basis of the associated aircraft type,
wherein the at least one optoelectronic sensor is an FMCW LiDAR sensor, and the measurement data comprise radial speeds of the measurement points.

2. The device in accordance with claim 1, wherein the control and evaluation unit is configured to segment the measurement points using the radial speeds of the measurement points.

3. The device in accordance with claim 1, wherein the control and evaluation unit is configured to associate the measurement points at least partially with segments of the aircraft using the radial speeds of the measurement points.

4. The device in accordance with claim 1, wherein the control and evaluation unit is configured to extract features of the segments using the radial speeds of the measurement points associated with the segments.

5. The device in accordance with claim 1, wherein the control and evaluation unit is configured to determine a movement pattern of at least one of the segments using the radial speeds of the measurement points associated with the segments.

6. The device in accordance with claim 1, wherein the control and evaluation unit is configured to filter the measurement points using the radial speeds of the measurement points.

7. The device in accordance with claim 1, wherein the control and evaluation unit is configured to determine a speed along a movement direction of the aircraft using the radial speeds of the measurement points

8. The device in accordance with claim 1, wherein the FMCW LiDAR sensor is configured to detect polarization dependent intensities of the transmitted light remitted or reflected by the measurement points and the measured data comprise the polarization dependent intensities.

9. The device in accordance with claim 8, wherein the control and evaluation unit is configured to segment the measurement points using the polarization dependent intensities and to at least partially combine them into segments of the aircraft.

10. The device in accordance with claim 8, wherein the control and evaluation unit is configured to filter the measurement points using the polarization dependent intensities.

11. The device in accordance with claim 1, wherein the device has at least one further FMCW LiDAR sensor having a further monitored zone and the monitored zone at least partly overlaps with the further monitored zone.

12. A method of detecting an aircraft in a monitored zone of an apron of an airport, said method comprising the steps:
transmitting transmitted light beams into the monitored zone using at least one FMCW LIDAR sensor:
scanning a plurality of measurement points in the monitored zone;
generating measurement data from transmitted light remitted or reflected by the measurement points, with the measurement data comprising radial speeds of the measurement points;
segmenting the measurement points and at least partially combining the measurement points into segments of the aircraft:
extracting features of the segments;
associating the segments with an aircraft type from a plurality of aircraft types with reference to the extracted features; and
outputting positioning information for the aircraft based on the associated aircraft type.

13. The method in accordance with claim 12, wherein the segmentation of the measurement points and the at least partial association of the measurement points with the object segments takes place using the radial speeds of the measurement points.

14. The method in accordance with claim 12, said method comprising the further step
determining a movement pattern of at least one of the segments using the radial speeds of the measurement points associated with the segments.

15. The method in accordance with claim 12. said method comprising the further step:
filtering the measurement points using the radial speeds of the measurement points.
